(19) United States
(12) Patent Application Publication
(10) Pub. No.: US 2005/0002852 A1
(43) Pub. Date: Jan. 6, 2005

(54) Process and apparatus for scrubbing sulfur dioxide from flue gas and conversion to fertilizer

(75) Inventors: Maurice Karras, Kingwood, TX (US); Douglas Jackson, Katy, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Cankar Ltd.

(21) Appl. No.: 10/901,607

(22) Filed: Jul. 29, 2004

Related U.S. Application Data
(62) Division of application No. 09/923,559, filed on Aug. 7, 2001, now abandoned.

(51) Int. Cl. C01B 17/64

(52) U.S. Cl. 423/514

(57) ABSTRACT

A method for removing sulfur dioxide from flue gas and forming ammonium salts is described, along with a method for conversion of the ammonium salts into thiosulfate. Also described are an apparatus for absorbing sulfur dioxide from flue gas and an apparatus for converting ammonium salts into thiosulfate. The apparatus for absorbing sulfur dioxide from flue gas includes a multistage scrubber. The apparatus for converting ammonium salts into thiosulfate includes a fluidized bed reactor.

### RELATED PATENT APPLICATION

This application is a divisional of U.S. patent application Ser. No. 09/923,559, filed Aug. 7, 2001 and entitled “Process and Apparatus for Scrubbing Sulfur Dioxide from Flue Gas and Conversion to Fertilizer”.

### FIELD OF THE INVENTION

The present invention relates to processes and apparatuses for removing sulfur dioxide from flue gas and reacting the resulting product to form a fertilizer. More specifically, in one process of the present invention, sulfur dioxide is scrubbed from flue gas by use of ammonia containing aqueous scrubbing solution, and the resulting scrubbed solution is reacted to form sulfonated compounds. The sulfonated compounds may be further reacted to form a fertilizer.

### BACKGROUND OF THE INVENTION

Utility and industrial plants, as part of their normal operation, produce undesirable combustion products such as sulfur dioxide. Sulfur dioxide is hazardous to the environment, may be viewed by the plant's neighbors as unpleasant or even noxious, and is highly regulated by local and national environmental agencies. Various methods have been used by utility and industrial plant owners to control the emissions of sulfur dioxide from their facilities. The most common include gas-liquid contactors and absorbers.

Typical gas-liquid contactors and absorbers scrub the sulfur dioxide from the flue gas effluent by contacting it with a liquid, solution, or slurry (hereinafter “liquid”) that absorbs the sulfur dioxide. In the typical gas-liquid contactor, flue gas enters near the base of the contactor, the absorbing liquid near the top. The descending absorbing liquid then scrubs the sulfur dioxide from the rising flue gas through absorption. Frequently, these liquids are alkaline and include calcium-based slurries such as calcium carbonate slurries formed from limestone, calcium hydroxide slurries formed from hydrated limes, and aqueous ammonia and ammonia-based liquids such as ammonium sulfate. These liquids react with the gases in the flue gas effluent, such as sulfur dioxide, to form salts. Typically, the liquids and reacted salts are collected near the bottom of the gas-liquid contactor and removed for further processing.

Gas-liquid contactors that use slurries are known to suffer from numerous shortfalls. Because it is not possible to fully dissolve the calcium-compound solids in the manufacture of the slurry, the slurry consists of small particle chunks in suspension. Reaction between these small chunks and the sulfur dioxide is inefficient because the sulfur dioxide molecules are incapable of reacting with the interior of the chunks. Further, the slurries have a tendency to settle, necessitating slurry agitation to minimize layering that will inevitably occur. In addition, these heavy slurries have a tendency to plug small orifices, such as spray nozzles within the gas-liquid contactors. Finally, the slurry cannot be efficiently atomized. As a consequence, the effectiveness of the gas-liquid contact is necessarily limited. The circulation of the slurry must therefore be increased to ameliorate some of these conditions, increasing costs for both equipment and operations.

While these typical gas-liquid contactors may scrub sulfur dioxide from the flue gas effluent to a regulatorily acceptable level, the flue gas effluent may carry part of the liquid or slurry with it as entrained liquid or entrained slurry. After this effluent leaves the gas-liquid contactor, it is discharged into the atmosphere. The entrained liquid or entrained slurry may create a new set of problems for the operator of the industrial plant. For instance, the typical operation of a gas-liquid contactor utilizing aqueous ammonia often produces an aerosol that appears as a bluish haze in the flue gas discharge. This aerosol is caused by the entrainment of ammonium salt crystals in the discharged flue gas. This haze is often clearly visible by the neighbors of the facility and often extends for miles beyond its point of origin, which may result in problems meeting associated air pollution regulations.

In addition to the problems associated with the flue gas effluent, the gas-liquid contactors using ammonia also produce large volumes of solutions containing sulfonated compounds such as ammonium sulfite (“sulfite”), ammonium bisulfite (“bisulfite”), ammonium sulfate (“sulfate”), and residual ammonia. Gas-liquid contactors using calcium-compound-based slurries produce wastes such as calcium sulfate and calcium sulfite. Most of these liquids present a disposal problem, as they contain chemicals regulated by state and federal agencies. While traditionally most of these liquids have been disposed of, it is possible to convert the sulfonated compounds to fertilizers. Processes used to convert these compounds have to date been mostly batch processes that were inefficient and expensive. In addition, these processes have often been open to the atmosphere, creating additional environmental pollution.

There is a need for an efficient means of removing sulfur dioxide from flue gas and conversion of the resulting compounds into an industrially useful product. The removal process should further not create other wastes, or create an opacity problem. The process of creating the industrially useful product should be closed to the atmosphere to reduce emissions.

### SUMMARY OF THE INVENTION

Accordingly, a multistage scrubber and thiosulfate conversion reactor are provided wherein a portion of the sulfur dioxide is removed from flue gas and may be converted into thiosulfate suitable for use as fertilizer. Further provided are associated methods for conversion of sulfur dioxide in flue gas into thiosulfate. In one embodiment of the present invention, a method for scrubbing sulfur dioxide from a flue gas stream is provided where the flue gas stream is contacted with a plurality of aqueous ammonia liquor streams and a scrubber product stream is formed composed, in part, of bisulfite and sulfite.

In another embodiment of the present invention, a multistage scrubber for removing sulfur dioxide from flue gas is shown, which consists of a vertically-oriented shell. The shell has a flue gas entry port and flue gas exit port. Associated with the shell are a number of liquid distributor headers within the interior cavity of the shell, each of the liquid distributor headers so located such that the liquid distributor headers are capable of receiving fluid. Also present are a plurality of liquid distributors, that are connected to the liquid distributor headers and capable of distributing fluid from the liquid distributor headers to the interior cavity of the shell. The scrubber also contains a number of scrubber stage separators, each scrubber stage separator substantially perpendicular to the vertical axis of the multistage scrubber. Fluid ports are located so that they are capable of removing liquid from the upper surface of the stage separators. The scrubber stage separators and liquid distributor headers are arranged as to form stages. Finally, a scrubber product line is included which is capable of removing liquid from the multistage separator

Also described is a process for manufacturing ammonium thiosulfate (“thiosulfate”) wherein a reactor feed stream containing ammonium sulfite or ammonium bisulfite is sent to a fluidized bed reactor containing solid sulfur where it is contacted with ammonia and reacted with sulfur and ammonia to form a thiosulfate product stream. Further, a thiosulfate reactor system is disclosed with consists of a fluidized bed reactor containing a bed of solid sulfur, a reactor feed stream, an ammonia feed line, a sulfur feed line, and a thiosulfate product line. The reactor feed stream, ammonia feed line, and sulfur feed lines each transport reactants to the bed of solid sulfur within the fluidized bed reactor. The thiosulfate product line is capable of removing the product thiosulfate.

### BRIEF DESCRIPTION OF THE DRAWINGS

FIG. 1 is a schematic of one embodiment of a multistage scrubber for removal of sulfur dioxide from flue gas according to the present invention.

FIG. 2 is a schematic of one embodiment of a thiosulfate plant according to the present invention.

FIG. 3 is a schematic of another embodiment of a thiosulfate plant according to the present invention.

### DETAILED DESCRIPTION OF THE INVENTION

In the present invention, a portion of the sulfur dioxide in an incoming flue gas stream is removed from the effluent flue gas through the use of a multistage scrubber. This multistage scrubber removes the sulfur dioxide from the flue gas by reacting it with ammonia.

There are two overall primary reactions that occur within the multistage scrubber:
SO₂+NH₃+H₂O→NH₄HSO₃ (bisulfite)
SO₂+2NH₃+H₂O→(NH₄)₂SO₃ (sulfite)

In practice, the actual reactions are:
(NH₄)₂SO₃+SO₂+H₂O⇄2NH₄HSO₃
NH₄HSO₃+NH₃⇄(NH₄)₂SO₃

The ratio of the bisulfite to sulfite produced depends primarily on pH. As pH rises, more sulfite is produced. Reducing the pH will correspondingly increase the relative ratio of bisulfite to sulfite. At a pH of below 5.8, the predominate product will be bisulfite. Because carbon dioxide will always be present in flue gas, the pH at which the reaction occurs should generally be kept acidic in order to reduce absorption of CO₂ where absorption of CO₂ is undesirable. In addition, because bisulfite is much more soluble than sulfite, decreasing the pH will allow a greater concentration of dissolved solids. This may be advantageous for flue gas with high SO₂ concentrations. Further, increasing the pH of the solution will result in a higher ammonia vapor pressure. Higher ammonia pressure near the outlet of the effluent flue gas from the multi stage scrubber may result in the formation of an ammonia compound aerosol. Accordingly, for these reasons, the pH of the solution nearest the flue gas effluent should be maintained below 6.5, and preferably below 5.8. However, absorber efficiency is also directly correlated to pH. A higher pH will generally result in increased absorption of SO₂. Therefore, a pH of 5.0 or more in solutions present in the multistage scrubber is preferred with proper scrubber operation, with a pH of greater than 5.4 most preferred to properly absorb the sulfur dioxide within the flue gas. Lower pH solutions may be used if lower efficiency may be tolerated.

In addition to the above reactions, where oxygen is present, an expected condition when flue gas is scrubbed, a small amount of the sulfur dioxide may react to form sulfate according to the following overall reaction:
SO₂+2NH₃+H₂O+½ O₂→(NH₄)₂SO₄ (sulfate)

In practice, the sulfite is formed first and the reaction appears as:
(NH₄)₂SO₃+½ O₂→(NH₄)₂SO₄

This reaction may be undesirable, particularly when eventual production of ammonium thiosulfate (“thiosulfate”) is desired. Reduction of oxygen within the system will minimize this reaction. When sulfate is the desired product, sulfate production may be increased by the addition of oxygen to the scrubber or in a downstream reactor. The reaction of sulfite to sulfate is a slower reaction than sulfur dioxide and ammonia to sulfite.

During a typical scrubber operation, solids produced by the scrubber will consist generally of about 50% to about 90% bisulfite, about 5% to about 45% sulfite, and the balance sulfate (all in weight percent). These concentrations may be modified by alteration of the scrubber conditions, such as introducing oxygen or changing the solution pH, as described previously. These solids will most often be present in an aqueous solution and the solution may also contain small amounts of ammonia and sulfur dioxide. Minor amounts of contaminants such as fly ash may also be present.

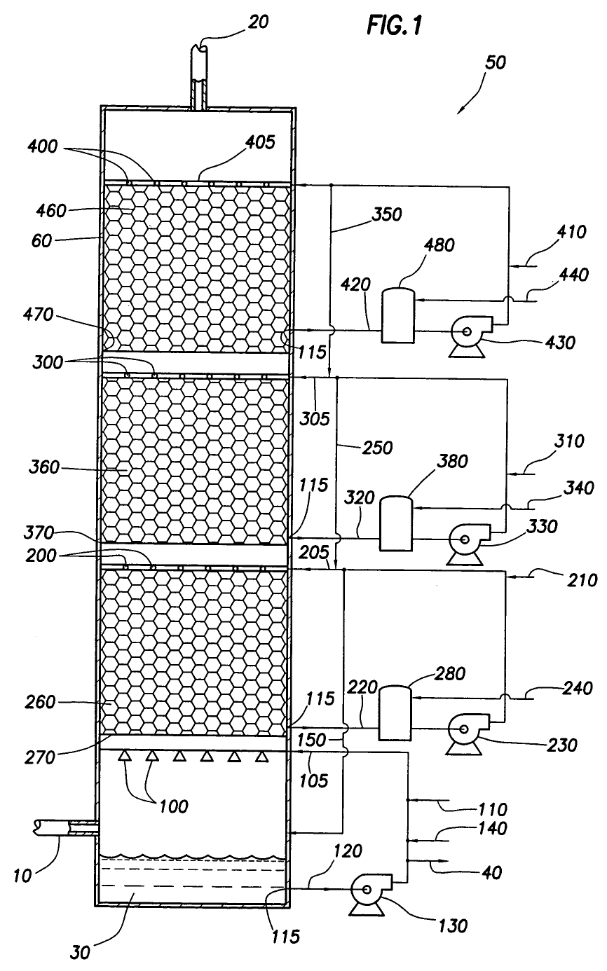

In the present invention, as shown in FIG. 1, multistage scrubber 50 is typically a vertically-oriented, gas-liquid contactor where flue gas and an ammonia liquor are commingled. Other orientations, including horizontal, are possible. The ammonia liquor is composed of at least water, unreacted ammonia, an absorbed sulfur dioxide gas, bisulfite, sulfite, and sulfate. Other sulfonated compounds may also be present. Multistage scrubber 50 consists primarily of shell 60, which may be constructed out of typical materials used in the manufacture of industrial equipment, often carbon steel. However, the internal surfaces that contact the acidic gases should be composed of materials able to withstand the extremely corrosive environment. Rubber lined equipment is commonly used, but glass-lined or epoxy-lined equipment, stainless steel equipment, and equipment made of more exotic alloys such as Hastelloy C276, zirconium and other like materials may also be used. Flue gas enters multistage scrubber 50 through flue gas entry point 10. The flue gas then rises through multistage scrubber 50 where it is contacted at various scrubber stages by a number of ammonia liquor streams. Flue gas entry port 10 should be located below scrubber stage one liquid distributors 100, but preferably above the highest level of liquid expected at the bottom of multistage scrubber 50, shown in FIG. 1 as liquid repository 30. The flue gas exits multistage scrubber 50 through flue gas exit port 20. Flue gas exit port 20 should be above the highest stage liquid distributors, shown in FIG. 1 as scrubber stage four liquid distributors 400, and may be located on the side of multistage scrubber or, as shown in FIG. 1, at the top of shell 60 of multistage scrubber 50.

Multistage scrubber 50 should have at least two scrubber stages, and preferably more than two. At each scrubber stage, the rising sulfur dioxide-containing flue gas is commingled with an aqueous ammonia liquor. The sulfur dioxide in the flue gas stream is reacted with the ammonia to form products including bisulfite, sulfite and sulfate. As the flue gas rises through multistage scrubber 50, sulfur dioxide is progressively removed.

The number of scrubber stages of multistage scrubber 50 may be determined based on the maximum concentration of sulfur dioxide desired at flue gas exit port 20, the initial concentration of sulfur dioxide in flue gas entry port 10, and the concentration of ammonium salts in the discharge from multistage scrubber 50. As those of skill in the art will appreciate, lower concentrations of sulfur-dioxide at flue gas exit port 20 generally require more scrubber stages than higher concentrations of sulfur dioxide at flue gas exit port 20, all other conditions and equipment being equal. Similarly, lower concentrations of sulfur dioxide at flue gas entry point 10 will require fewer scrubber stages than higher concentrations. It is possible with proper scrubber operation to obtain sulfur dioxide concentration reductions of greater than 99%. A flue gas effluent sulfur dioxide concentration of less than 100 ppm by weight is achievable by use of this technology.

On each scrubber stage of multistage scrubber 50 except for the top scrubber stage, the ammonia liquor used to contact the rising flue gas may be formed by combining recirculated liquor from that particular scrubber stage, together with fresh ammonia, fresh water, and a portion of the ammonia liquor from the scrubber stage above it. The top scrubber stage liquor is typically composed only of recirculated liquor from the top scrubber stage, fresh ammonia, and fresh water, although a fresh ammonia and fresh water only stream may be used. Scrubber stages are numbered from the bottom of the scrubber to the top, i.e., the bottom-most scrubber stage is numbered one, and in one embodiment, such as that depicted in FIG. 1, the top scrubber stage is numbered four. Note that during column operation, at any particular point in time, the actual portion of the ammonia liquor recirculated to multistage scrubber 50 and/or sent to the scrubber stage immediately below it may range from 0-100% of the total recirculated liquor stream. Other piping schemes are possible, and those of skill in the art will appreciate situations where streamflow between stages may be altered from that described.

The composition of the liquor at each scrubber stage is critical to the overall operation of multistage scrubber 50. Ammonium concentrations are generally highest at the bottom of the scrubber, lowest at the top. In this way, ammonia at the top level of the scrubber may be kept low to minimize the amount of ammonium crystals that leave multistage scrubber 50 through flue gas exit port 20. In order to reduce the risk of formation of the ammonium aerosol, multistage scrubber 50 should be designed to reduce the ammonia concentration above the highest scrubber stage of multistage scrubber 50 below 10 ppm, preferably below 5 ppm, and most preferably at 3 ppm or less (all by weight). This ammonium concentration is the total concentration of all the ammonia compounds, including bisulfite, sulfite, and sulfate.

Fresh ammonia and water may be added to each scrubber stage in order to control column operation. Fresh ammonia is added for at least two purposes. First, reaction of ammonia with the sulfur dioxide depletes the sulfur dioxide when the reaction produces bisulfite, sulfite, and sulfate, making replacement of the ammonia used necessary to continue the scrubbing process. Second, control of the pH of the liquor may be directly controlled through the use of ammonia. As ammonia is added, the bisulfite is converted to sulfite. As the more acidic bisulfite is converted to sulfite, the pH of the liquor rises, maintaining the liquor's sorbent activity.

Fresh water may be added to control the solution concentration. Solution concentration reflects the amount of dissolved solids in the ammonia liquor. Dissolved solids within multistage scrubber 50 are primarily ammonium salts, i.e., bisulfite, sulfite, and sulfate. High solution concentrations on the top-most scrubber stage of multistage scrubber 50 may result in noticeable emissions of sulfonated compounds. Solutions close to saturation concentration may result in solids plugging the equipment. However, low solution concentration may result in production of an ammonia liquor that has no commercial value and/or requires excessive downstream processing. It is therefore preferred to keep ammonia liquor solutions concentrations in liquid repository 30 of multistage scrubber 50 between 25 and 55%, often between 30 and 40% (by weight). Water may be added to the ammonia liquor to maintain the desired solution concentration, and further to increase the amount of ammonia liquor leaving multistage scrubber 50. It is possible to control desired solution concentration by only adding water to the ammonia liquor on select scrubber stages instead of all scrubber stages. When water is added only on select scrubber stages, it is important that the top scrubber stage be one of the scrubber stages upon which water is added or control of solution concentration will be difficult on the uppermost scrubber stage as, generally, no other liquids enter this stage.

The flue gas entering the first scrubber stage of multistage scrubber 50 may be contacted with a liquor stream having an ammonia salt concentration of between about 30 and about 55%. Subsequent scrubber stages may use less concentrated solutions of ammonium salts. In one embodiment where multistage scrubber 50 is a four stage scrubber and the inlet sulfur dioxide concentration is between 1500 and 2500 ppm (by weight), the second scrubber stage ammonium salt solution may be between 12 and 22%, the third scrubber stage between 5 and 10%, and the fourth scrubber stage between 0.5 and 1.1%. Scrubbers with more or fewer scrubber stages, or those with different concentrations of sulfur dioxide in the flue gas, will have different solution concentrations.

In one embodiment of the present invention, shown in FIG. 1, multistage scrubber 50 is a four scrubber stage scrubber. In FIG. 1, flue gas entering shell 60 of multistage scrubber 50 through gas entry port 10 is conveyed to scrubber stage one. The ammonia liquor is introduced to scrubber stage one through scrubber stage one liquid distributors 100. Scrubber stage one liquid distributors 100 may be of any configuration commonly used in the art for gas-liquid contactors and should provide good dispersion and vapor-liquid contact. One suitable configuration is a jet nozzle, although those of skill in the art will recognize other apparatuses that provide similar vapor-liquid contact. The ammonia liquor is forced through scrubber stage one liquid distributors 100 and falls through scrubber stage one to create liquid repository 30. Scrubber stage one liquid distributors supply the ammonia liquor through scrubber stage one liquid distributor header 105.

While falling through scrubber stage one, the ammonia liquor contacts the flue gas, where it absorbs a portion of the sulfur dioxide that is reacted to form bisulfite, sulfite, and sulfate. Fresh ammonia may be added to scrubber stage one through scrubber stage one ammonia supply 110. Fresh water may be added to scrubber stage one through water supply line 140. The ammonia liquor is removed from liquid repository 30 through at least one fluid exit port 115 via scrubber stage one liquor removal line 120. Removal is typically accomplished through scrubber stage one pump 130. A portion of the ammonia liquor may be removed from scrubber stage one liquor removal line 120 and sent for further processing through scrubber product line 40. The remaining ammonia liquor in scrubber stage one removal line 120 may be conveyed through scrubber stage one liquid distributor header 105 to scrubber stage one liquid distributors 100. A portion of the liquid from scrubber stage two may be sent to liquid repository 30 through scrubber stage two drain header 150.

The ammonia liquor withdrawn from multistage scrubber 50 through scrubber product line 40 may preferably contain more than 20 wt % sulfites (ammonium bisulfite and ammonium sulfite), more preferably greater than 25 wt %. The overall dissolved solids concentration (sulfites plus sulfate) should be equal to or less than 55% to avoid formation of the ammonia aerosol.

After absorption of a portion of the sulfur dioxide in the flue gas stream during scrubber stage one, the flue gas exits scrubber stage one through scrubber stage two separator 270. Scrubber stage two separator 270 is designed to allow flue gas flow from scrubber stage one to scrubber stage two and to collect liquid present in scrubber stage two. Most often, scrubber stage two separator 270 is a chimney tray, although those of skill in the art will be familiar with other suitable constructions capable of performing the same function. Liquid present on the upper surface of scrubber stage two separator 270 is collected and removed through at least one fluid exit port 115 via scrubber stage two liquor removal line 220.

Like scrubber stage one, scrubber stage two consists of scrubber stage two liquid distributors 200, scrubber stage two ammonia supply 210, and scrubber stage two pump 230, which operate essentially identically to their scrubber stage one counterparts. Scrubber stage two liquid distributors may also be of a jet configuration, but are more preferably simply small apertures on a header distribution system. Scrubber stage two liquid distributors 200 should be designed to fully wet any packing present in scrubber stage two, the use of which is described below. The ammonia liquor is collected and removed from the surface of scrubber stage one/scrubber stage two separator 270 through at least one fluid exit port 115 through scrubber stage two liquor removal line 220 as described in scrubber stage one. This liquor is removed from the upper surface of scrubber stage two separator 270. A drain portion of the ammonia liquor from scrubber stage two liquor removal line 220 is conveyed to scrubber stage one through scrubber stage two drain header 150. As described previously, this stream may be routed to other locations, as needed, such as, for instance, further processing or to an alternate disposition within multistage scrubber 50. The remaining recycle portion of the ammonia liquor in scrubber stage two removal line 220 may be combined in scrubber stage two tank 280 with makeup water from scrubber stage two water supply 240, when necessary, and conveyed through scrubber stage two liquid distributor header 205 to scrubber stage two liquid distributors 200. Alternatively, scrubber stage two water supply line 240 could be connected to scrubber stage two liquid distributor header 205. Scrubber stage two tank 280 acts as a surge tank, improving inventory control for each scrubber stage. Scrubber stage two tank 280 should be designed so that its volume is large compared to interstage flows; preferably, scrubber stage two tank 280 should be designed to contain at least 10 minutes of interstage, i.e. drain portion flow. Scrubber stage two tank 280 may be composed of any materials appropriate for ammonia and dissolved solids of sulfonated compounds including stainless steel, carbon steel lined with an epoxy coating or rubber, certain grades of Hastelloy or other like materials. In the alternative, scrubber stage two tank 280 may be eliminated, albeit at the cost of certain amount of inventory control. A portion of the liquid from scrubber stage three may be conveyed to scrubber stage two liquor supply 250 or to other needed alternate disposition sites.

Scrubber stage two may be operated much the same as scrubber stage one, in that liquid distributors are used to commingle the ammonia liquor onto the rising flue gas, converting some of the remaining sulfur dioxide to bisulfite, sulfite, and sulfate. Alternatively, as shown in FIG. 1, scrubber stage two may be composed of a combination of liquid distributors and packing. Scrubber stage two liquid distributors 200 wet packing 260 with the ammonia liquor. The rising flue gas then contacts the ammonia liquor present on packing 260, converting a portion of the sulfur dioxide in the flue gas to bisulfite, sulfite, and sulfate. Although not shown on FIG. 1, it is possible to use packing and liquid distributing on stage one in the manner described for stage two. When packing is used, nozzles are generally not desirable as liquid distributors as the liquid flowing from the nozzle may damage the packing. One alternative for liquid distributors used with a stage packing is to simply drill holes in the supplying liquid distributor header.

The type of packing used in multistage scrubber 50 is critical to the separation of sulfur dioxide from the flue gas. Because multistage scrubber 50 must handle a large volume of flue gas, typically with a small concentration of sulfur dioxide, it is important that the packing used in multistage scrubber 50 be highly efficient, compact, have a low irrigation rate, and have a low pressure drop. While those of skill in the art will appreciate that it is possible to increase the diameter of multistage scrubber 50 and use a lower-efficiency, higher-pressure drop packing, this may become cost prohibitive because of the huge volumes of flue gas typically treated in multistage scrubber 50. Normally, the pressure drop associated with the packing in multistage scrubber 50 should be less than 0.5 inches of water/foot of packing. Further, because of the corrosivity of the environment in multistage scrubber 50, standard materials may not be appropriate. Stainless steel is one example of a packing material of construction that is appropriate, specifically austenetic stainless steel although other materials with similar properties would also function in this application. An example of packing that will function appropriately in multistage scrubber 50 is type A3, wire gauze packing manufactured by ACS/Montz. Typically, packing will be supported by methods familiar to those of skill in the art.

Proper irrigation of the packing, where packing is used, is important to the operation of multistage scrubber 50. Proper scrubber operation requires that there be adequate contact between the flue gas and the absorbing ammonia liquor. However, proper irrigation increases the pressure drop across the packing, increasing pump sizes and making high efficiency packing important. This proper irrigation leads to the most efficient use of the vertical height of multistage scrubber 50.

Scrubber stages three and four operate much the same as scrubber stage two, and the following work in the same manner as described for the scrubber stage two counterparts: scrubber stage three liquid distributors 300, scrubber stage four liquid distributors 400, scrubber stage two liquid distributor header 205, scrubber stage three liquid distributor header 305, scrubber stage four liquid distributor header 405, scrubber stage three ammonia supply 310, scrubber stage four ammonia supply 410, scrubber stage three pump 330, scrubber stage four pump 430, scrubber stage three separator 370, scrubber stage four separator 470, scrubber stage three liquor removal line 320, scrubber stage four liquor removal line 420, scrubber stage three tank 380, scrubber stage four tank 480, scrubber stage three water supply 340, scrubber stage four water supply 440, scrubber stage three packing 360, and scrubber stage four packing 460.

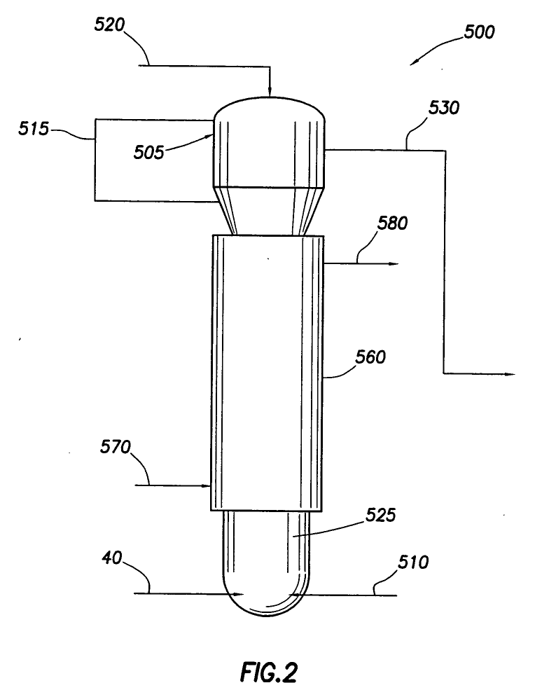

After processing in multistage scrubber 50, ammonia liquor leaving multistage scrubber 50 through scrubber product line 40 may be disposed of, reacted to form sulfate, or sent to a facility for further processing to produce thiosulfate, a chemical desirable in the manufacture of certain types of fertilizer or as fertilizer itself. FIG. 2 depicts one embodiment of thiosulfate facility 500.

In thiosulfate facility 500 shown in FIG. 2, bisulfite and sulfite react with ammonia and sulfur according to the following equations to produce thiosulfate:
NH₄HSO₃+NH₃+S→(NH₄)₂S₂O₃
(NH₄)₂SO₃+S→(NH₄)₂S₂O₃

The reaction of bisulfite to thiosulfate is believed to be a two-step reaction, wherein bisulfite is first converted to sulfite by reaction with ammonia and thereafter converted to thiosulfate with sulfur as shown in the second equation. Sulfate produced in multistage scrubber 50 is not converted and proceeds through thiosulfate plant 500 as an inert compound.

In one embodiment shown in FIG. 2, thiosulfate plant 500 is composed of a fluidized bed reactor 505 in which the liquid ammonia liquor flows upward through a bed of solid sulfur. It is important that the temperature of the fluidized bed in reactor 500 not exceed 243° F., as the sulfur bed will melt, resulting in reactor shutdown. It is preferred to keep the temperature of the sulfur bed below 200° F.

The sulfur in the bed is generally in pellet form, although any form allowing efficient and intimate contact of the ammonia liquor with the bed of sulfur is acceptable. Fluidized bed reactor 505 should be constructed of materials appropriate for the corrosive environment in which it operates, i.e., high temperature and sulfonated compounds. Acceptable materials of construction include stainless steel, carbon steel lined with rubber or epoxy, and more exotic alloys such as some grades of Hastelloy and other like materials. Fluidized bed reactor 505 should be designed to maximize the contact between the ammonia liquor, the ammonia, and the sulfur bed present within fluidized bed reactor 505. To that end, liquid velocities through the bed should be kept low, preferably under 2 inches per second, more preferably under 1.5 inches per second. As those of skill in the art will appreciate, an operator may trade liquid velocity for vessel diameter and/or height to achieve a desired residence time.

As shown in FIG. 2, fluidized bed reactor 505 may have an expanded vapor space section 515 at the top of fluidized bed reactor 505. Expanded upper vapor space section 515 is designed to reduce the velocity at the outlet of the reactor and reduce carryover of the fine solid sulfur particles. Expanded vapor space section 515 further serves to introduce replacement sulfur into the vessel, as described below.

The ammonia liquor entering thiosulfate plant 500 through scrubber product line 40 (also termed a reactor feed stream) is mixed and reacted with ammonia through ammonia feed line 510 and sulfur through sulfur feed line 520. Sulfur added through sulfur feed line 520 may be molten sulfur and is added to replace the sulfur from the fluidized bed that reacts to form thiosulfate. The sulfur entering fluidized bed reactor 505 should be distributed across the diameter of the reactor where possible. Two acceptable methods are to spray the molten sulfur into fluidized bed reactor 505 through a jet nozzle or through a perforated tray. When the molten sulfur enters fluidized bed reactor 505, it freezes in pellet or granular form and is added to the remaining sulfur in the fluidized bed. In another embodiment, solid sulfur is introduced to fluidized bed reactor 505 through a rotary valve. In this alternative embodiment, the sulfur is in solid pellet form, rather than molten. Reacted ammonia liquor leaves fluidized bed reactor 505 through reactor discharge line 530.

Reaction of bisulfite and sulfite to thiosulfate is exothermic, as is the reaction of ammonia and the sulfite/bisulfite solution. The latter may be violent. Upon initial startup of thiosulfate plant 500, it may be desirable to add ammonia to scrubber product line 40 prior to entry to fluidized bed reactor 505 and thereby reduce the vigor of the reaction within fluidized bed reactor 505. This may be done in a recirculated tank or with an in-line mixer. Further, cooling of fluidized bed reactor 505 may be desirable. Reaction chamber 525 of fluidized bed reactor 505 should be kept at a temperature below 243° F., preferably below 200° F., and most preferably below 160° F. Suitable means for cooling fluidized bed reactor 505 include internal coils, cooling water jacket, and external cooler such as a heat exchanger. Water, brine, or refrigerants may be circulated through the cooling apparatus to remove heat from fluidized bed reactor 505. In one embodiment shown in FIG. 2, cooling water jacket 560 is supplied with water through cooling water supply line 570. The heated water discharged from cooling water jacket 560 is removed through cooling water discharge line 580.

It is preferable to limit the concentration of bisulfite and sulfite in reactor discharge line 530 to less than 1 wt %, more preferably less than 0.1 wt %, in order to maximize the amount of thiosulfate in the final product. Higher concentrations of bisulfite and sulfite are allowable for some industrial uses, and therefore, higher concentrations of bisulfite and sulfite in the reactor discharge line may be appropriate.

The discharge from fluidized bed reactor in FIG. 2 may contain some small amount of solid contaminants such as fly ash. These solids may be filtered from the discharge liquid. Further, the concentration of thiosulfate leaving the fluidized bed reactor may not be of commercial grade thiosulfate quality, i.e. typically 55% or higher dissolved solids and commonly referred to as 12-0-0-26 or better (nitrogen, phosphorous, potassium and sulfur). This concentration may be enriched by removing some of the water present in the discharge liquid. It is possible to remove the water by any number of acceptable methods, including a flash evaporator or a quencher. In the flash evaporator, a portion of the water is removed by either heating the discharge liquid or dropping its pressure or both. In a quencher, heat from the flue gas discharge from the utility or incinerator may be cross-exchanged with the discharge liquid, heating it and causing some of the water in the discharge liquid to vaporize. After the flash evaporator or the quencher, the discharge liquid may then be cooled to prevent later crystallization of the dissolved solids.

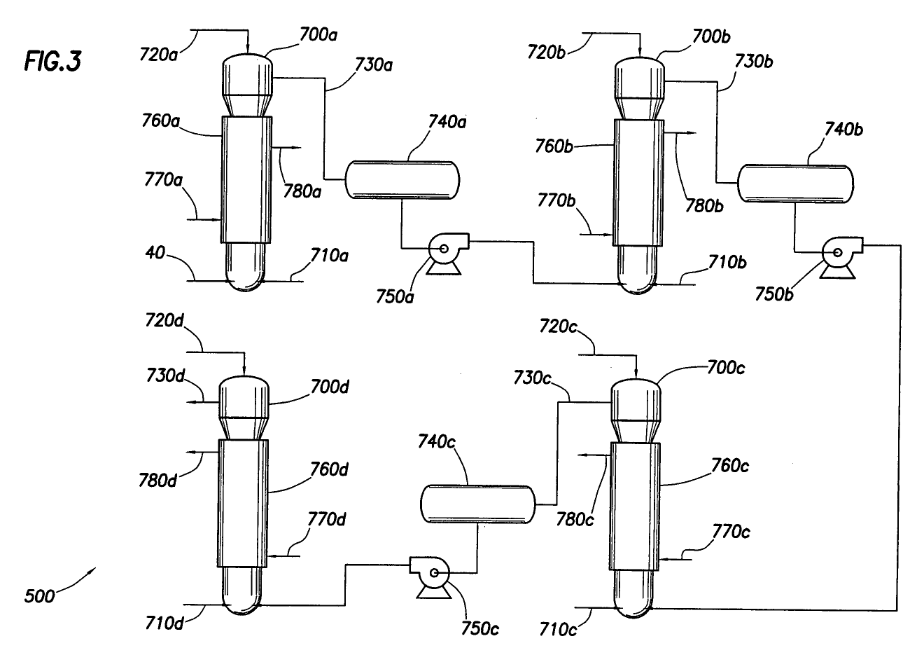

In another embodiment shown in FIG. 3, thiosulfate plant 500 is composed of four individual reactors, reactors 700a-700d. In the embodiment depicted in FIG. 3, all of the reactors are essentially identical, although this is not a requirement of the present invention. Reactors 700a-700d are fluidized bed reactors that are constructed similarly and operate essentially identically to fluidized bed reactor 505.

The ammonia liquor entering thiosulfate plant 500 in FIG. 3 through scrubber product line 40 is mixed and reacted with ammonia through ammonia feed line 710a and sulfur through sulfur feed line 720a. Ammonia and sulfur are transported to reactors 700b-700d through ammonia feed lines 710b-710d and sulfur feed lines 720b-720d respectively. Reacted ammonia liquor leaves reactors 700a-700d through reactor discharge lines 730a-730d, which are collected in intermediate thiosulfate storage tanks 740a-740c. Reactor feed pumps 750a-750c are used to transport the reacted ammonia liquor from intermediate thiosulfate storage tanks 740a-740c to the next reactor in series.

Reaction of bisulfite and sulfite to thiosulfate is exothermic, and cooling of reactors 700a-700d is desirable. The reaction chamber of reactors 700a-700d should be kept at a temperature below 243° F., preferably below 200° F. Suitable means for cooling reactors 700a-700d include internal coils, cooling water jacket, and external coolers such as a heat exchanger. Brine, refrigerant, or cooling water may be circulated through these cooling devices. In one embodiment shown in FIG. 3, cooling water jackets 760a-760d are supplied with water through cooling water supply lines 770a-770d. The heated water discharged from cooling water jackets 760a-760d is removed through cooling water discharge lines 780a-780d. In an alternative embodiment, it is possible to merely insulate reactor 700a and use the heat of reaction to assist in bringing the incoming reactants to reaction temperature.

Reactors 700a-700d progressively convert the bisulfite and sulfite present in thiosulfate supply line 260 into thiosulfate. It is preferable to limit the concentration of bisulfite and sulfite in reactor discharge line 730d to less than 1 wt %, more preferably less than 0.1 wt %. While FIG. 3 depicts four fluidized bed reactors in series, it is possible to use more or fewer reactors, depending on the degree of conversion desired and the efficiency of conversion in each reactor.

The discharge from the final reactor in the series, 700d in FIG. 2, may contain some small amount of solid contaminants such as fly ash. These solids may be filtered from the discharge liquid. Further, the concentration of thiosulfate leaving the last reactor in the sequence, shown as 700d in FIG. 2, may not be of commercial grade thiosulfate quality, i.e. typically 55% or higher dissolved solids and commonly referred to as 12-0-0-26 or better (nitrogen, phosphorous, potassium, and sulfur). This concentration may be enriched by removing some of the water present in the discharge liquid, as previously discussed related to FIG. 2.

Although the present invention has been described with reference to specific details, it is not intended that such details should be regarded as limitations upon the scope of the invention, except as and to the extent that they are include in the accompanying claims.

1. A method for manufacturing thiosulfate from a flue gas stream, the flue gas stream having an initial sulfur dioxide concentration, comprising the following steps:
(a) contacting the flue gas stream with a plurality of aqueous ammonia liquor streams;
(b) forming a scrubber product stream scrubber product stream comprising ammonium bisulfite and ammonium sulfite;
(c) flowing the scrubber product stream through a fluidized bed reactor containing solid sulfur; and
(d) contacting the reactor feed stream with ammonia; and
(e) reacting the scrubber product feed stream, sulfur and ammonia to form a thiosulfate product stream.

2. The method as described in claim 1 further comprising:
forming each of the aqueous ammonia liquor streams by combining a water stream and an ammonia stream.

3. The method as described in claim 1, wherein each of the aqueous ammonia liquor streams has a pH of between 5.0 and 6.0.

4. The method as described in claim 3, wherein each of the aqueous ammonia liquor streams has a pH of between 5.4 and 5.8.

5. The method of claim 1, wherein contacting the flue gas stream with a plurality of aqueous ammonia liquor streams is accomplished through the use of liquid distributors.

6. The method of claim 5, wherein the liquid distributors are nozzles.

7. The method as described in claim 1, wherein the total dissolved solids of the scrubber product stream are about 50 to about 90% ammonium bisulfite, by weight.

8. The method as described in claim 1, wherein the total dissolved solids of the scrubber product stream are about 5 to about 45% sulfite, by weight.

9. The method as described in claim 1, further comprising after contacting the flue gas stream with a plurality number of aqueous ammonia liquor streams:
producing a flue gas effluent stream, the flue gas effluent stream having a final sulfur dioxide concentration.

10. The method as described in claim 9, wherein the flue gas effluent stream has a final sulfur dioxide concentration of less than 100 ppm by weight.

11. The method as described in claim 9, wherein the flue gas effluent stream has a final sulfur dioxide concentration of less than 1% of the flue gas initial sulfur dioxide concentration.

12. The process according to claim 1, wherein step (e) is performed at a reaction temperature of less than 243° F.

13. The process according to claim 1, wherein the solid sulfur is in pellet form.

14. The process according to claim 1, wherein the fluid velocity of the reactor feed stream through the fluidized bed of sulfur is less than 2 inches per second.

15. The process according to claim 14, wherein the fluid velocity of the reactor feed stream through the fluidized bed of sulfur is less than 1.5 inches per second.

16. The process according to claim 1, further comprising:
adding a molten sulfur make-up stream to the fluidized bed of sulfur.

17. The process according to claim 16, wherein the step of adding a molten sulfur make-up stream to the fluidized bed of sulfur is performed by spraying the molten sulfur through a nozzle.

18. The process according to claim 1, wherein the concentration of ammonium bisulfite in combination with ammonium sulfite in the thiosulfate product stream is less than 1%.

19. The process according to claim 18, wherein the concentration of ammonium bisulfite in combination with ammonium sulfite in the thiosulfate product stream is less than 0.1%.

20. The process according to claim 1, wherein concentration of dissolved solids in the thiosulfate product stream is greater than 55%.

21. The process according to claim 1, further comprising after step (d): (e) removing a portion of the water from the thiosulfate product stream to form a discharge liquid.

22. The process according to claim 21, wherein the step of removing water from the thiosulfate product stream is accomplished by the use of a flash evaporator or quencher.

23. The process according to claim 22, further comprising:
(f) cooling the discharge liquid.

24. A method for manufacturing a scrubber product stream comprising ammonium sulfite or ammonium bisulfite comprising:
(a) providing a multistage scrubber for removing sulfur dioxide from flue gas comprising a vertically-oriented shell, the shell having an upper end and a lower end, the shell further having a flue gas entry port and flue gas exit port, the shell further having an interior cavity, a vertical axis, and an interior surface; N number of liquid distributor headers within the interior cavity of the shell, so located such that the liquid distributor headers are capable of receiving fluid, wherein N is greater than 1 and wherein the liquid distribution headers are numbered from 1 to N; a plurality of liquid distributors, the liquid distributors in fluid communication with the liquid distributor headers and capable of distributing fluid from the liquid distributor headers to the interior cavity of the shell; N-1 number of scrubber stage separators numbered 2 to N along the vertical axis, each of the scrubber stage separators located in a plane substantially perpendicular to the vertical axis, each scrubber stage separator having an upper surface; a plurality of fluid exit ports, each fluid exit port capable of withdrawing liquid from the upper surface of a particular scrubber stage separator; N number of stages numbered 1 to N wherein each of the stages numbered 2 to N comprise the correspondingly numbered liquid distribution header, the correspondingly numbered scrubber stage separator, and at least one of the fluid exit ports and stage 1 comprises the correspondingly numbered liquid distribution header and at least one fluid exit port; a scrubber product line, the scrubber product line capable of removing fluid from the multistage scrubber;
(b) supplying a flue gas stream comprising sulfur dioxide;
(c) supplying an ammonia stream;
(d) supplying a water stream; and
(e) reacting the water stream, ammonia stream and sulfur dioxide within the multistage scrubber to form a scrubber product stream, the product stream comprising ammonium sulfite or ammonium bisulfite.

25. A method for manufacturing a thiosulfate product stream comprising ammonium thiosulfate comprising:
(a) providing a thiosulfate reactor system comprising a fluidized bed reactor, the fluidized bed reactor having an interior cavity, an interior surface, an exterior surface, a circumference, a bottom portion and an upper portion; a bed of solid sulfur, the bed of solid sulfur being contained within the interior cavity of the fluidized bed reactor; a reactor feed stream, the reactor feed stream being connected to the bottom portion of the fluidized bed reactor such that the fluid is capable of flowing from the reactor feed stream to the interior cavity of the fluidized bed reactor; an ammonia feed line, the ammonia feed line being connected to the fluidized bed reactor such that fluid is capable of flowing from the ammonia feed line to the interior cavity of the fluidized bed reactor; a sulfur feed line, the sulfur feed line being connected to the upper portion of the fluidized bed reactor such that fluid is capable of flowing from the sulfur feed line to the interior cavity of the fluidized bed reactor; and a thiosulfate product line, the thiosulfate product line connected to the fluidized bed reactor such that fluid may be removed from the fluidized bed reactor;
(b) supplying an ammonium bisulfite or ammonium sulfite stream;
(c) supplying a sulfur stream;
(d) supplying an ammonia stream; and
(e) reacting the sulfur stream, ammonia stream and ammonium bisulfite or ammonium sulfite stream within the thiosulfate reactor system to form a thiosulfate product stream comprising ammonium thiosulfate.

26. A method for manufacturing a thiosulfate product stream comprising ammonium thiosulfate comprising:
(a) providing a multistage scrubber for removing sulfur dioxide from flue gas comprising a vertically-oriented shell, the shell having an upper end and a lower end, the shell further having a flue gas entry port and flue gas exit port, the shell further having an interior cavity, a vertical axis, and an interior surface; N number of liquid distributor headers within the interior cavity of the shell, so located such that the liquid distributor headers are capable of receiving fluid, wherein N is greater than 1 and wherein the liquid distribution headers are numbered from 1 to N; a plurality of liquid distributors, the liquid distributors in fluid communication with the liquid distributor headers and capable of distributing fluid from the liquid distributor headers to the interior cavity of the shell; N-1 number of scrubber stage separators numbered 2 to N along the vertical axis, each of the scrubber stage separators located in a plane substantially perpendicular to the vertical axis, each scrubber stage separator having an upper surface; a plurality of fluid exit ports, each fluid exit port capable of withdrawing liquid from the upper surface of a particular scrubber stage separator; N number of stages numbered 1 to N wherein each of the stages numbered 2 to N comprise the correspondingly numbered liquid distribution header, the correspondingly numbered scrubber stage separator, and at least one of the fluid exit ports and stage 1 comprises the correspondingly numbered liquid distribution header and at least one fluid exit port; a scrubber product line, the scrubber product line capable of removing fluid from the multistage scrubber;
(b) providing a thiosulfate reactor system comprising a fluidized bed reactor, the fluidized bed reactor having an interior cavity, an interior surface, an exterior surface, a circumference, a bottom portion, and an upper portion; a bed of solid sulfur, the bed of solid sulfur being contained within the interior cavity of the fluidized bed reactor; a reactor feed stream, the reactor feed stream being connected to the scrubber product line and bottom portion of the fluidized bed reactor such that the fluid is capable of flowing from the scrubber product line through the reactor feed stream to the interior cavity of the fluidized bed reactor; an ammonia feed line, the ammonia feed line being connected to the fluidized bed reactor such that fluid is capable of flowing from the ammonia feed line to the interior cavity of the fluidized bed reactor; a sulfur feed line, the sulfur feed line being connected to the upper portion of the fluidized bed reactor such that fluid is capable of flowing from the sulfur feed line to the interior cavity of the fluidized bed reactor; and a thiosulfate product line, the thiosulfate product line connected to the fluidized bed reactor such that fluid may be removed from the fluidized bed reactor;
(c) supplying a flue gas stream comprising sulfur dioxide;
(d) supplying a first ammonia stream;
(e) supplying a water stream;
(f) reacting the water stream, the first ammonia stream and sulfur dioxide within the multistage scrubber to form a scrubber product stream, the product stream comprising ammonium sulfite or ammonium bisulfite;
(g) supplying a sulfur stream;
(h) supplying a second ammonia stream; and
(i) reacting the sulfur stream, the second ammonia stream, and the scrubber product stream within the thiosulfate reactor system to form a thiosulfate product stream comprising ammonium thiosulfate.
